(19) United States
(12) Patent Application Publication
(10) Pub. No.: US 2024/0330970 A1
(43) Pub. Date: Oct. 3, 2024

(54) SYSTEMS AND METHODS FOR DYNAMICALLY ASSESSING CANDIDATE USER ELIGIBILITY IN AFFILIATE PROGRAMS

(71) Applicant: Wells Fargo Bank, N.A., San Francisco, CA (US)

(72) Inventors: Debashis Ghosh, Charlotte, NC (US); Maria Chiarenza, Indian Trail, NC (US); Stephanie Simon, Olney, MD (US); Daniel Mertes, Chanhassen, MN (US)

(21) Appl. No.: 18/193,273

(22) Filed: Mar. 30, 2023

(51) Int. Cl. G06Q 30/0207

(52) U.S. Cl. CPC G06Q 30/0224; G06Q 30/0236

(57) ABSTRACT

Systems, apparatuses, methods, and computer program products are disclosed for assessing affiliate program eligibility of a candidate user. An example method includes determining an engagement status of the candidate user with respect to an organizational entity determined to be associated with the candidate user. The method further includes evaluating whether the candidate user is eligible for one or more affiliate programs based on the engagement status for the candidate user with respect to the organizational entity and in an instance the candidate user is eligible for at least one of the one or more affiliate programs, generating an eligibility notification, wherein the eligibility notification describes the one or more affiliate programs for which the candidate user is eligible. The method further includes providing the eligibility notification to the candidate user.

### BACKGROUND

Modem systems may utilize data to provide services. The data relevant to a particular implementation may exist in a plurality of data sources throughout a distributed system.

### BRIEF SUMMARY

Communication systems facilitate a broad array of interactions between devices and users thereof. As part of these interactions, the devices may obtain data from one or more data sources. The data may drive the performance of computer-implemented services based on the data. In some embodiments, the data may be associated with a user or a collection of users (e.g., a family). User data may be available or sourced from a variety of data sources but may require additional processing. Nevertheless, such data may include comprehensive and detailed information that may be leveraged to solve a variety of complex issues.

For example, a provider entity may contract with a recipient entity to provide services and benefits to the associates of the recipient entity via a program that the recipient entity may enroll in. By virtue of the recipient entity's enrollment in the program, the associates of the recipient entity may be eligible for the services and benefits offered by the program. In a particular example, a financial institution may offer discounted rates and other benefits to employees of a company via a program that the company may engage in. However, traditionally the recipient entity (e.g., the company) may be tasked with providing information regarding the services and benefits offered by the provider entity (e.g., the financial institution) to the associates (e.g., employees) while the provider entity may be uninformed regarding the specific associates of the recipient entity.

This is problematic for several reasons. Firstly, the recipient entity is oftentimes unfamiliar with the specifics and details of a program and thus may be ill-equipped and/or unprepared to answer inquiries made by associates regarding the program. Thus, this can lead to increased user friction and dissatisfaction and may further increase labor and computational costs devoted to trying to resolve the inquiry in this inefficient manner. Additionally, the recipient entity may only provide information regarding program information at certain time intervals (e.g., yearly benefit reminders) and further, are uninformed regarding associate life events that may benefit from the program such that the associates may not be reminded and/or informed at critical times such that they miss out on time-critical services and benefits. For example, a new employee looking to purchase a house due to relocation from a new job, may be uninformed that the company they are employed by is enrolled in a corporate mortgage benefit program that offers special mortgage benefits, financial education tools and assistance, and more, that may help facilitate the purchase of his/her new home. Thus, these associates may miss out on services and benefits that are offered to them by virtue of their association with the recipient entity.

To address these technical issues and others, embodiments described herein address the issue of conventional user eligibility notifications by proactively identifying the eligibility of users associated with an organizational entity that is enrolled in one or more offered affiliate programs and furthermore, provide them with a notification of their eligibility for said affiliate programs. As such, these users may take advantage of these offered services and benefits of the affiliate program and may further be in a position to ask informed parties (associated with the affiliate programs) any questions they may have, thereby streamlining communications and enhancing the overall user experience.

To do so, internal source data may be leveraged to infer the user's employment or association with an organizational entity. The internal source data may include income data sourced from one or more of direct deposit documents, paycheck documents, or self-reported income for candidate user and an organizational entity may be identified. In some embodiments, the internal source data may further include any financial information such as user transactions, user issued checks, credit applications, mortgage applications, and/or the like. This information may then be used to determine an engagement status for the user with respect to the organizational entity (e.g., an entity described by internal source data). The organizational entity may then be evaluated to determine whether it is enrolled in one or more affiliate programs. In an instance the engagement status of the user is eligible, and the organizational entity is enrolled in one or more affiliate programs, the system may determine that the user is eligible for the one or more affiliate programs and may generate and provide an eligibility notification to the user. In an instance the engagement status of the user is ineligible and/or the organizational entity is not enrolled in one or more affiliate programs, the system may continue to monitor and/or identify internal source data pertaining to the user and may re-evaluate user eligibility based on new data.

Furthermore, in some embodiments, certain trigger events may be identified for a user via the internal source data and may cause the eligibility of the user to be evaluated. As such, a dynamic and real-time eligibility determination may be made for the user and the user may be informed of their eligibility in one or more affiliate programs such that they may take advantage of the offered services and/or benefits. For example, a job change (inferred via the internal source data) may be a trigger event that is identified for a user and the new employer of the user may be identified from the internal source data. If the new employer is enrolled in an affiliate program, such as the corporate mortgage benefit program, the user may be informed of this via an eligibility notification and may thus inform the user of this such that he/she may engage with the program's offered services and benefits to help facilitate a required move and purchase of a new house.

In some embodiments, the eligibility of a user may additionally or alternatively be evaluated based on a linked organizational entity rather than the organizational entity the user is directly associated with. For example, if the organizational entity is a subsidiary of a parent linked organizational entity, the enrollment of the linked organizational entity in one or more affiliate programs may be evaluated. If the linked organizational entity is determined to be associated with one or more affiliate programs, then a set of criteria for each affiliate program may be evaluated to determine whether a user of the organizational entity may be eligible for the affiliate program via the relationship by virtue of the relationship between the organizational entity and the linked organizational entity. Thus, this may allow for more robust and comprehensive user eligibility determinations to be made. Traditionally, users associated with an organizational entity may be largely uninformed or unaware of the potential benefits offered by an affiliate program they may be eligible for in an instance a linked organizational entity is enrolled in the affiliate program, but the organizational entity directly associated with the users is not.

Additionally, in some embodiments, even in instances when an organizational entity is not currently enrolled in any affiliate programs or is not enrolled in a particular affiliate program, many users associated with the organizational entity may currently be associated with the entity offering the one or more affiliate programs. For example, many employees of a certain company that is currently not enrolled in any affiliate programs may be current customers of a particular financial institution which offers said affiliate programs. As such, a large number of employees of the company may benefit from the affiliate program in an instance the company was enrolled in an affiliate program. As such, in some embodiments, an affiliate program recommendation may be generated for organizational entities which are currently not enrolled in any affiliate programs or in a particular affiliate program such that the organizational entity is made aware of the potential benefit to be had via enrollment into an affiliate program.

In one example embodiment, a method is provided for assessing affiliate program eligibility of a candidate user. The method includes determining, by user evaluation circuitry, an engagement status of the candidate user with respect to an organizational entity associated with the candidate user and evaluating, by candidate management circuitry and based on the engagement status of the candidate user with respect to the organizational entity, whether the candidate user is eligible for one or more affiliate programs. The method further includes, in an instance in which the candidate user is eligible in at least one of the one or more affiliate programs, generating, by the candidate management circuitry, an eligibility notification, wherein the eligibility notification describes the one or more affiliate programs for which the candidate user is eligible and providing, by communications hardware, the eligibility notification to the candidate user.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for assessing the eligibility of a candidate user for one or more affiliate programs.

FIG. 2 illustrates a schematic block diagram of example circuitry embodying a system device that may perform various operations in accordance with some example embodiments described herein.

FIG. 3 illustrates an example flowchart for providing an eligibility notification to a candidate user, in accordance with some example embodiments described herein.

FIG. 4 illustrates an example flowchart for determining an engagement status for a candidate user with respect to an organizational entity, in accordance with some example embodiments described herein.

FIG. 5 illustrates an example flowchart for evaluating if a candidate user is eligible for one or more affiliate programs, in accordance with some example embodiments described herein.

FIG. 6 illustrates an example flowchart for evaluating if a candidate user is eligible for one or more affiliate programs using one or more linked organizational entities, in accordance with some example embodiments described herein.

FIG. 7 illustrates an example flowchart for providing an affiliate program recommendation, in accordance with some example embodiments described herein.

FIG. 8 illustrates a swim lane diagram with example operations that may be performed by components of the environment depicted in FIG. 1, in accordance with some example embodiments described herein.

FIG. 9 illustrates an example user interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “candidate user” may refer to a user who is being evaluated for eligibility in one or more affiliate programs. A candidate user may be any user who is associated with an organizational entity offering one or more affiliate programs. A candidate user may further be associated with internal source data and/or a user profile that includes internal source data. In some embodiments, internal source data includes income data sourced from one or more sources such as direct deposit documents, paycheck documents, or self-reported income. In some embodiments, the internal source data may further include any financial information such as user transactions, user issued checks, credit applications, mortgage applications, and/or the like. Additionally, internal source data may be associated with one or more temporal values, such as a date or receipt, a date of deposit, a date or issuance, etc. In some embodiments, the candidate user may further be associated with demographic information, which may be described in an associated user profile and/or by the internal source data.

The term “organizational entity” may refer to an entity that is associated with one or more users. In some embodiments, an organizational entity may refer to a business, company, union, association, organization, and/or the like. In some embodiments, the organizational entity may be enrolled in one or more affiliate programs and/or may be eligible for one or more affiliate programs. In an instance an organizational entity is enrolled in an affiliate program, the users associated with the organizational entity (e.g., employees, members, organizers, etc.) may be eligible for the services and benefits offered by the affiliate program by virtue of their association with the organizational entity. In some embodiments, supplemental data may be associated with the organizational entity and may describe information regarding the type of organization (e.g., limited liability company (LLC), subchapter S corporation (S Corp), sole proprietorships, partnerships, corporation, non-profit, charity, union, etc.), the number of users associated with the organizational entity, office locations, profits, etc. In some embodiments, an organizational entity profile associated with the organizational entity may store the supplemental information. In some embodiments, the organizational entity profile may also include an indication of one or more linked organizational entities associated with the organizational entity. For example, a graph structure, look-up table, reference table, and/or the like may be used to store and maintain relationships between the organizational entity and one or more linked organizational entities. For example, a node within a graph structure may indicate the organizational entity and the other nodes within the graph structure may indicate the linked organizational entities. The edges or connections between nodes may then indicate the relationship and/or connection between the organizational entity and linked organizational entities as well as the relationship and/or connection between linked organizational entities. In some embodiments, the edges may be directional such that the relationships and/or connections may be further described in the graph structure. For example, a directional edge directed away from a linked organizational entity node to the organizational entity node may indicate the organizational entity is a subsidiary of the linked organizational entity.

The term “linked organizational entity” may refer to an entity that is associated with or related to the organizational entity in some form or fashion. For example, a linked organizational entity may be a parent company, a sister company, a subsidiary, an affiliate, a division, a branch, a joint venture, an acquired company, a “doing business as” (DBA) company, and/or the like with respect to the organizational entity. In some embodiments, a linked organizational entity may refer to a business, company, union, association, organization, and/or the like. In some embodiments, the linked organizational entity may be enrolled in one or more affiliate programs and/or may be eligible for enrollment in one or more affiliate programs. In an instance a linked organizational entity is enrolled in an affiliate program, the users associated with the linked organizational entity (e.g., employees, members, organizers, etc.) and in some embodiments, the organizational entity may be eligible for the services and benefits offered by the affiliate program by virtue of their association with the linked organizational entity and/or organizational entity. In some embodiments, supplemental data may be associated with the linked organizational entity and may describe information regarding the type of organization (e.g., LLC, S Corp, sole proprietorships, partnerships, corporation, non-profit, charity, union, etc.), the number of users associated with the linked organizational entity, office locations, profits, etc. In some embodiments, an organizational entity profile associated with the linked organizational entity may store the supplemental information. In some embodiments, the organizational entity profile may also include an indication of one or more linked organizational entities associated with the linked organizational entity.

The term “affiliate program” may refer to a structured program offer in which an organizational entity may enroll in. An affiliate program may be associated with various services and/or benefits and that may be offered to users of an enrolled organizational entity. In some embodiments, each affiliate program may be associated with a set of criteria for which an organizational entity must satisfy before enrollment. The organizational entities enrolled in the affiliate program may be stored and maintained in a program affiliate repository. As such, the currently organizational entities enrolled in a particular affiliate program may be determined via the program affiliate repository.

The term “program affiliate repository” may refer to a structured data repository or database configured to store a set of organizational entities enrolled in each offered affiliate program. The program affiliate repository may be queried for a particular organizational entity and return each affiliate program the organizational entity is enrolled in. Alternatively, the program affiliate repository may be queried for a particular affiliate program and return each enrolled organizational entity enrolled in the particular affiliate program. The program affiliate repository may be updated in response to changes made to affiliate programs and/or the one or more organizational entities enrolled in the affiliate program. For example, the program affiliate repository may be updated to reflect newly enrolled organizational entities upon completion of the enrollment process. As another example, the program affiliate repository may be updated to reflect organizational entities that opt to be removed from an affiliate program upon termination of their enrollment. As such, the information and/or data store by the program affiliate repository may be up-to-date and accurate.

### System Architecture

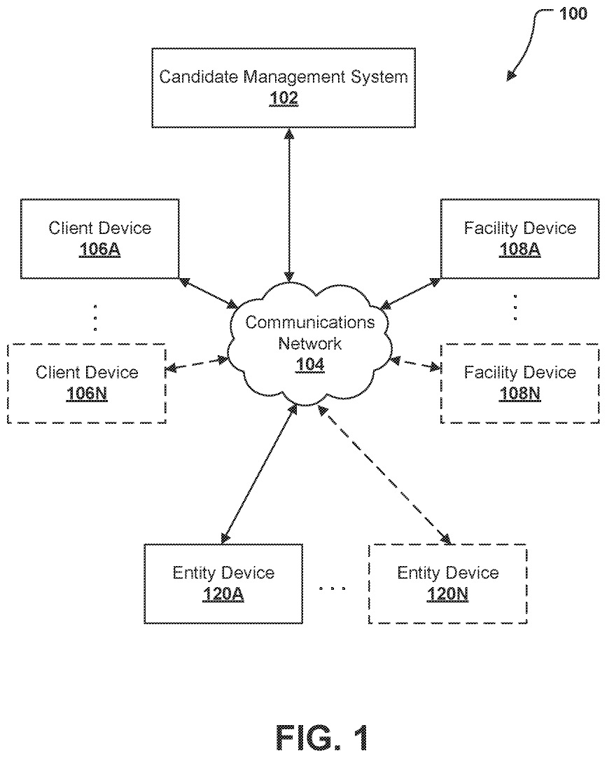

Example embodiments described herein may be implemented using any of a variety of computing devices or servers. To this end, FIG. 1 illustrates an example environment 100 within which various embodiments may operate. As illustrated, a candidate management system 102 may receive and/or transmit information via communications network 104 (e.g., the Internet) with any number of other devices, such as one or more of client devices 106A-106N, facility devices 108A-108N, and/or entity devices 120A-120N.

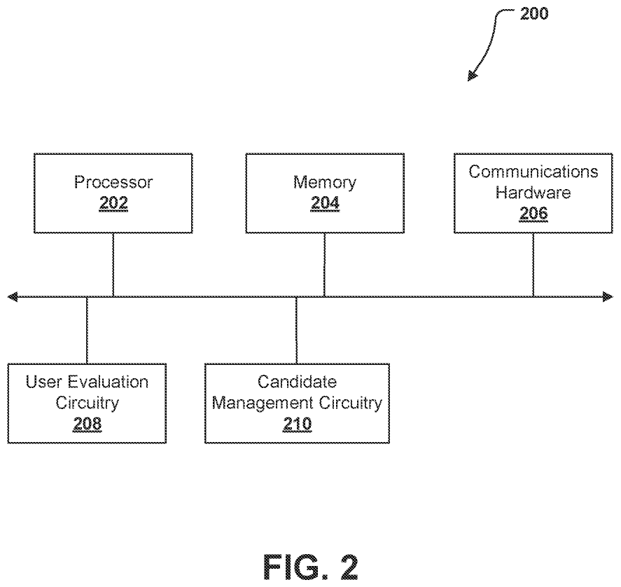

The candidate management system 102 may be implemented as one or more computing devices or servers, which may be composed of a series of components. Particular components of the candidate management system 102 are described in greater detail below with reference to apparatus 200 in connection with FIG. 2.

In some embodiments, the candidate management system 102 further includes a storage device (not shown) that comprises a distinct component from other components of the candidate management system 102. A storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the candidate management system 102. The storage device may store information relied upon during operation of the candidate management system 102, such as various income data that may be used by the candidate management system 102, data and documents to be analyzed using the candidate management system 102, or the like. In addition, the storage device may store control signals, device characteristics, and access credentials enabling interaction between the candidate management system 102 and one or more of the client devices 106A-106N, and/or facility devices 108A-108N. In some embodiments, the storage device may be configured to store and/or host the program affiliate repository.

The one or more client devices 106A-106N, the one or more entity device 120A-120N, and the one or more facility devices 108A-108N may be embodied by any computing devices known in the art. The one or more client devices 106A-106N, the one or more entity devices 120A-120N, and the one or more facility devices 108A-108N need not themselves be independent devices, but may be peripheral devices communicatively coupled to other computing devices. In some embodiments, a client device (e.g., client devices 106A-106N) may be associated with a candidate user. In some embodiments, an entity device (e.g., entity devices 120A-120N) may be associated with an organizational entity or a linked organizational entity. In some embodiments, a facility device (e.g., facility devices 108A-108N) may be associated with the entity that operates the candidate management system 102 and/or maintains the program affiliate repository.

Although FIG. 1 illustrates an environment and implementation in which various functionalities are performed by different devices, in some embodiments some or all of the functionalities of the candidate management system 102, client devices 106A-106N, entity devices 120A-120N, and facility devices 108A-108N may be aggregated into a single device.

### Example Implementing Apparatuses

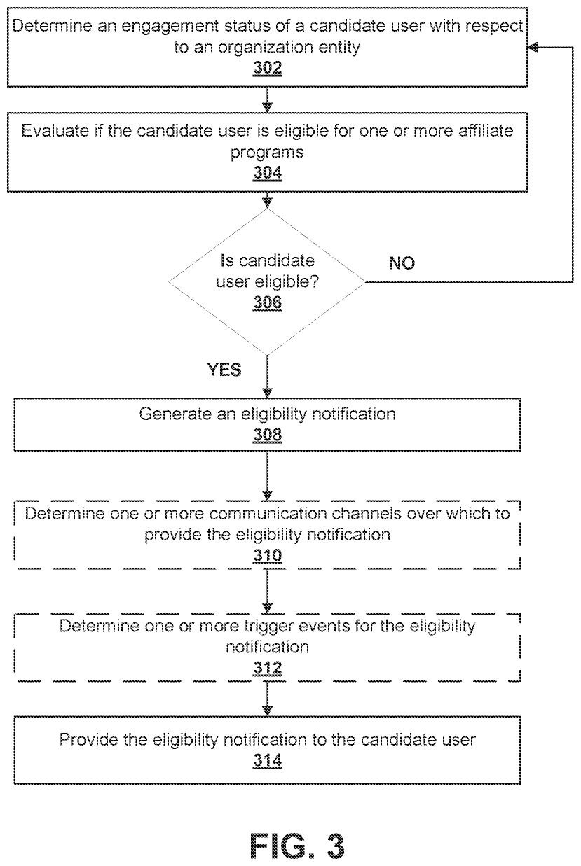

The candidate management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-9. As illustrated in FIG. 2, the apparatus 200 may include processor 202, memory 204, communications hardware 206, user evaluation circuitry 208, and candidate management circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein. In some embodiments, memory 204 may be configured to store and/or host the program affiliate repository, user profiles, and/or organizational entity profiles and their associated data.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a user evaluation circuitry 208 that may be configured to determine an engagement status for the candidate user with respect to an organizational entity determined to be associated with the candidate user. In some embodiments, the user evaluation circuitry 208 may further be configured to identify internal sources data pertaining to a candidate user and evaluate the internal source data to identify an organizational entity associated with the candidate user. In some embodiments, the user evaluation circuitry 208 may further be configured to identify temporal information described by the internal source data and further, determine the engagement status of the candidate user based on the temporal information. In some embodiments, the user evaluation circuitry may further be configured to identify demographic information pertaining to the candidate user and may further determine the engagement status of the candidate user based on said demographic information. The user evaluation circuitry 208 may utilize processor 202, memory 204, or any other hardware component included in the apparatus 200 to perform these operations, as described in connection with FIGS. 3-8 below. The user evaluation circuitry 208 may further utilize communications hardware 206 to gather data from a variety of sources (e.g., any of client devices 106A-106N, entity devices 120A-120N, and/or facility devices 108A-108N, as shown in FIG. 1), and/or exchange data with a user.

In addition, the apparatus 200 further comprises a candidate management circuitry 210 that may be configured to evaluate whether the candidate user is eligible for one or more affiliate programs and generate and provide an eligibility notification. In some embodiments, the candidate management circuitry 210 may further be configured to query a program affiliate repository for the organizational entity associated with the candidate user and may be configured to receive the results of the query. The candidate management circuitry 210 may further be configured to determine whether the organizational entity is eligible for one or more affiliate programs based on the results of the query. In some embodiments, the candidate management circuitry 210 may further be configured to determine whether the engagement status of the candidate user corresponds to one or more eligible engagement statuses. In some embodiments, the candidate management circuitry 210 may be configured to identify one or more linked organizational entities associated with the organizational entity and may further be configured to query the program affiliate repository for the one or more linked organizational entities. The candidate management circuitry 210 may further be configured to determine whether the organizational entity is eligible for one or more affiliate programs based on the results of the query using the one or more linked organizational entities. In some embodiments, the candidate management circuitry 210 may further be configured to determine one or more communication channels over which to provide the eligibility notification and/or may be configured to determine one or more trigger events for the eligibility notification. In some embodiments, the candidate management circuitry 210 may further be configured to identify a total organizational entity user count and determine whether the total organizational entity user count satisfies one or more total organizational entity user count thresholds and may further generate and provide and affiliate program recommendation.

The candidate management circuitry 210 may utilize processor 202, memory 204, or any other hardware component included in the apparatus 200 to perform these operations, as described in connection with FIGS. 3-8 below. The candidate management circuitry 210 may further utilize communications hardware 206 to gather data from a variety of sources (e.g., any of client devices 106A-106N, entity devices 120A-120N, and/or facility devices 108A-108N) as shown in FIG. 1), and/or exchange data with a user.

Although components 202-210 are described in part using functional language, it will be understood that the particular implementations necessarily include the use of particular hardware. It should also be understood that certain of these components 202-210 may include similar or common hardware. For example, the user evaluation circuitry 208 and candidate management circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the user evaluation circuitry 208 and candidate management circuitry 210 may leverage processor 202, memory 204, or communications hardware 206 as described above, it will be understood that any of evaluation circuitry 208 and candidate management circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that evaluation circuitry 208 and candidate management circuitry 210 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200 and 300, example embodiments are described below in connection with a series of graphical user interfaces and flowcharts.

### Example Operations

FIGS. 3-7, example flowcharts are illustrated that contain example operations implemented by example embodiments described herein. The operations illustrated in FIGS. 3-7 may, for example, be performed by system device of the candidate management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, user evaluation circuitry 208, candidate management circuitry 210, and/or any combination thereof. It will be understood that user interaction with the candidate management system 102 may occur directly via communications hardware 206, or may instead be facilitated by a separate client device (e.g., any one of client devices 106A-106N), a separate entity devices (e.g., any one of entity devices 120A-120N), and/or a separate facility device (e.g., any one of facility devices 108A-108N), as shown in FIG. 1, and which may have similar or equivalent physical componentry facilitating such user interaction.

Turning first to FIG. 3, example operations are shown for providing an eligibility notification to a candidate user. More particularly, via the operations described in FIG. 3, an eligibility of the candidate user for one or more affiliate programs may be assessed and in an instance the user is eligible for said one or more affiliate programs, the user may be made aware of the programs and his/her eligibility via the eligibility notification. In doing so, the candidate management system 102 may automatically and dynamically assess the up-to-date eligibility and inform the users of their eligibility without reliance on third-parties.

As shown by operation 302, the apparatus 200 includes means, such as processor 202, memory 204, communications hardware 206, user evaluation circuitry 208, or the like, for determining an engagement status of a candidate user with respect to an organizational entity. A candidate user may refer to an individual or user to be evaluated for eligibility in one or more affiliate programs. In order to evaluate the eligibility of the candidate user for an affiliate program, an engagement status must be determined for the candidate user with respect to an organizational entity. In some embodiments, the organizational entity associated with the candidate user and the engagement status may be inferred using internal source data and/or a user profile of the candidate user.

A candidate user may further be associated with internal source data and/or a user profile that includes internal source data. In some embodiments, internal source data includes income data sourced from one or more sources such as direct deposit documents, paycheck documents, or self-reported income. In some embodiments, the internal source data may further include any financial information such as user transactions, user issued checks, credit applications, mortgage applications, and/or the like. Additionally, internal source data may be associated with one or more temporal values, such as a date or receipt, a date of deposit, a date or issuance, etc. In some embodiments, the candidate user may further be associated with demographic information, which may be described in an associated user profile and/or by the internal source data. This internal source data may be used to determine an engagement status for the user.

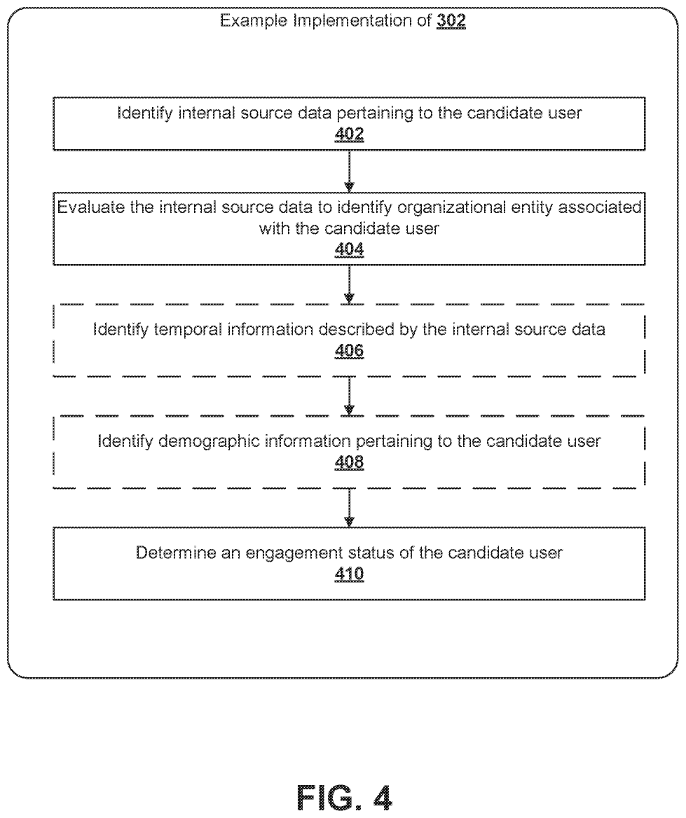

In some embodiments, operation 302 may be performed in accordance with the operations described by FIG. 4. Turning now to FIG. 4, example operations are shown for determining an engagement status of the user with respect to the organizational entity.

As shown by operation 402, the apparatus 200 includes means, such as processor 202, memory 204, communications hardware 206, user evaluation circuitry 208, or the like, for identifying internal source data pertaining to the candidate user. As described above, internal source data may be associated with the candidate user. This internal source data may be determined and/or received from a variety of sources. For example, the user evaluation circuitry 208 may be configured to receive internal source data via a client device (e.g., any one of client devices 106A-106N) which may correspond to a candidate client device. As another example, the user evaluation circuitry 208 may be configured to receive internal source data via an entity device (e.g., any one of entity devices 120A-120N), which may correspond to an organizational entity device. For example, a candidate user may use a mobile checking application to deposit a paper paycheck issued by his/her employer and may use his/her client device to do so. As another example, an organizational entity may pay the candidate user using a direct deposit document. In some embodiments, internal source data may be received from a facility device (e.g., any one of facility devices 108A-108N). For example, a candidate user may visit a financial institution branch and provide recent paystubs to a financial institution employee during a mortgage application process. As such, the financial institution employee may enter the information of the paystubs into a facility device such that internal source data is received from the facility device. As such, the internal source data may already be stored and/or associated with a user profile associated with a candidate user.

In an instance the internal source data is not already stored or associated with a user profile, the user evaluation circuitry 208 may be configured to receive the internal source data and may store this internal source data in the user profile associated with the candidate user. The internal source data may include identifying information pertaining to the candidate user such that the user evaluation circuitry 208 may identify the appropriate candidate user and corresponding user profile the internal source data corresponds to. For example, the internal source data may include an account identifier, a user identifier, a user name, user credentials, and/or the like such that the user evaluation circuitry 208 may be identify the candidate user based on this information. In some embodiments, the user evaluation circuitry 208 may employ natural language processing techniques (NLP) and/or optical character recognition techniques to identify this the information included within the internal source data and subsequently identify the appropriate candidate user and user profile corresponding to the internal source data.

Once the received internal source data has been stored in the user profile, the user evaluation circuitry 208 may access the user profile of the candidate user and identify the internal source data associated with the candidate user. In some embodiments, the user evaluation circuitry 208 may perform additional operations when identifying internal source data pertaining to the candidate user. For example, in some embodiments, the user evaluation circuitry 208 may only identify internal source data corresponding to a particular selection time window. For example, the user evaluation circuitry 208 may identify only internal source data associated with a date and/or timestamp occurring within a 2 month selection time window. As such, the user evaluation circuitry 208 may selectively identify the most recent and up-to-date internal source data for a user.

As shown by operation 404, the apparatus 200 includes means, such as processor 202, memory 204, communications hardware 206, user evaluation circuitry 208, or the like, for evaluating the internal source data to identify an organizational entity associated with the candidate user. Once the user evaluation circuitry 208 has identified the internal source data, the user evaluation circuitry 208 may evaluate and/or process the internal source data to identify the organizational entity associated with the candidate user.

In some embodiments, the user evaluation circuitry 208 may be configured to use one or more processing models when processing the internal source data. In some embodiments, the one or more processing models may be trained machine learning models (e.g., neural networks such as convolutional neural networks (CNNs)) that may process identified internal source data and identify an organizational entity. In some embodiments, the one or more processing models may additionally or alternatively employ NLP techniques and/or optical character recognition techniques to perform these operations. In some embodiments, the organizational entity is determined based on the context within the internal source data. For example, internal source data may be a credit application and include the text “employer” and text “ABC Corp” directly adjacent to the “employer” text. As such, the one or more processing models may identify the organizational entity to be “ABC Corp” based on the “employer” context in the internal source data. As another example, internal source data may be a direct deposit document and include the text “ABC Corp” as well as a text indicating the routing number and account number of the payroll account used to fund the direct deposit. As such, the one or more processing models may identify the organizational entity as “ABC Corp” based on the text “ABC Corp” and/or the routing number and account number. In some embodiments, if the routing number is associated with the candidate management system 102, the user evaluation circuitry 208 may perform a lookup of the organizational entity associated with the account number to identify the organizational entity. In some embodiments, the one or more processing models may additionally determine a candidate user, temporal information, and/or the like. In some embodiments, the one or more processing models may additionally determine supplemental information associated with the internal source data. For example, the one or more processing models may identify text on a memo line of an issued check and include this as supplemental information. The one or more processing models may output this information to the user evaluation circuitry, which may then identify the organizational entity associated with the candidate user based on this output.

For example, internal source data may be sourced from a direct deposit document, which may indicate a date or issuance of the deposit, a recipient (e.g., the candidate user), an issuer (e.g., an organizational entity), and/or the like. As such, the one or more processing models may be configured to process the direct deposit document (e.g., sourced data) and determine the candidate user receiving the direct deposit, the organizational entity which issued the payment, and a date the direct deposit was issued and output this information.

Optionally, as shown by operation 406, the apparatus 200 includes means, such as processor 202, memory 204, communications hardware 206, user evaluation circuitry 208, or the like, for identifying temporal information described by the internal source data. As described above, in some embodiments, the internal source data may be associated with temporal information, such as a date of deposit, a date of receipt, a data of issuance, etc. Additionally, in some embodiments, the one or more processing models used in operation 404 may additionally identify temporal information described by the internal source data. For example, a paper check image (e.g., received via mobile deposit) may be processed by the one or more processing models and the date of the paper check may be identified and output by the one or more processing models.

Optionally, as shown by operation 408, the apparatus 200 includes means, such as processor 202, memory 204, communications hardware 206, user evaluation circuitry 208, or the like, for identifying demographic information pertaining to the candidate user. In some embodiments, the user profile associated with the candidate user may include demographic information (e.g., age, family status, location, education, etc.). This demographic information may be maintained and/or collected in various ways. For example, when a candidate user opens an account, applies for a new service or product, updates his/her information, etc., the demographic information may be updated and stored in the user profile of the corresponding candidate user.

As shown by operation 410, the apparatus 200 includes means, such as processor 202, memory 204, communications hardware 206, user evaluation circuitry 208, or the like, for determining an engagement status of the candidate user. Once the organizational entity associated with the candidate user has been identified as described above, an engagement status may be determined for the candidate user with respect to the organizational entity. An engagement status may be indicative of the relationship of the candidate user with the organizational entity. For example, an engagement status may include an employed engagement status, newly employed engagement status, resigned engagement status, retired engagement status, active engagement status, inactive engagement status, and/or the like.

In some embodiments, the particular engagement status may depend on the organizational entity type associated with the organizational entity. For example, an organizational entity may be a company or business which includes employees such that applicable engagement statuses include an employed engagement status, newly employed engagement status, resigned engagement status, or retired engagement status. As another example, an organizational entity may be a union or association which has members who may pay member dues and thus have applicable engagement statuses which include an active engagement status or inactive engagement status. The organizational entity type may be determined using an organizational entity repository, which may describe various organizational entities and their corresponding organizational entity type. The organizational entity repository may include organizational entities which may not necessarily be associated with the one or more affiliate programs to allow for a more robust and complete list of organizational entities and the corresponding type. In some embodiments, the organizational entity repository may be maintained and/or managed by one or more administrators and/or may be automatically updated based on verified information (e.g., data sourced from reputable sources such as the internal revenue service).

The user evaluation circuitry 208 may use the identified internal source data to determine an engagement status of the user. In some embodiments, in an instance temporal information and/or demographic information may additionally be used to determine an engagement status of the candidate user. For example, the user evaluation circuitry 208 may determine whether the temporal information associated with the internal source data occurred within a particular time frame and determine an engagement status accordingly. For example, the user evaluation circuitry 208 may determine whether the internal source data occurred within a two-week time frame and if so, may determine the engagement status of the candidate user to be “employed”. As such, the user evaluation circuitry 208 may infer that since the internal source data occurred within a recent time frame, the candidate user is currently employed by the organizational entity. In an instance the internal source data did not occur within the two-week time frame, the user evaluation circuitry 208 may determine the engagement status of the candidate user to be “resigned”.

In some embodiments, the user evaluation circuitry 208 may use one or more inference models to determine an engagement status of the candidate user. The one or more inference models may be trained machine learning models (e.g., neural networks) that are configured to process the internal source data and optionally the temporal information and/or demographic information to infer an engagement status of the user with respect to the organizational entity. The one or more inference models may additionally use historical candidate user data (e.g., historical internal source data that was not selected for the user because it occurred outside the selection time window) to determine an engagement status. The one or more inference models may be trained to infer engagement statuses for candidate users based on additional context (e.g., such as temporal information, demographic information, historical candidate user data, etc.). The one or more inference models may output the engagement status for the user once provided information is processed.

For example, the one or more inference models may determine that a candidate user is 65 years old based on the demographic information and has historically received a direct deposit from the organizational entity “ABC Corp” every 2 weeks based on the historical candidate user data. However, the internal source data and temporal data may indicate that the candidate user has not received a direct deposit from “ABC Corp” within the past 2 weeks. As such, the one or more inference models may determine an engagement status of “retired” for the candidate user with respect to the organizational entity “ABC Corp”.

As another example, the one or more inference models may determine that a candidate user is 25 years old based on the demographic information and has historically received a direct deposit from the organizational entity “ABC Corp” every 2 weeks based on the historical candidate user data. The internal source data and temporal data may indicate that the candidate user has deposited a new check from “XYZ Corp” and is associated with supplemental information indicating text of “sign-on bonus” on the memo line. Thus, the one or more inference models may determine an engagement status of “newly employed” for the candidate user with respect to the organizational entity “XYZ Corp”.

As yet another example, the one or more inference models may determine that a candidate user is 25 years old based on the demographic information. The internal source data and temporal data may indicate that the candidate user has issued a new check to “Union 123” and is associated with supplemental information indicating text of “membership dues” on the memo line. Thus, the one or more inference models may determine an engagement status of “active” for the candidate user with respect to the organizational entity “Union 123”.

Retuning now to FIG. 3, as shown by operation 304, the apparatus 200 includes means, such as processor 202, memory 204, communications hardware 206, candidate management circuitry 210, or the like, for evaluating whether the candidate user is eligible for one or more affiliate programs. An affiliate program may refer to a structured program offer in which an organizational entity may enroll in. An affiliate program may be associated with various services and/or benefits and that may be offered to users of an enrolled organizational entity. For example, an affiliate program may include a corporate mortgage benefit program that offers special mortgage benefits for employees of an enrolled company and may further offer financial education tools and resources. As another example, an affiliate program may be a relocation mortgage program that offers special mortgage benefits and support during a relocation process.

In some embodiments, each affiliate program may be associated with a set of criteria for which an organizational entity must satisfy in order to be eligible for enrollment. For example, in some embodiments, the set of criteria for an affiliate program may specify which organizational entity types may qualify for enrollment in the affiliate program. The set of criteria may also specify a required total organizational user count threshold which the organizational entity must satisfy to be enrolled in the affiliate program. Additionally or alternatively, the set of criteria may specify one or more engagement statuses which a candidate user associated with an enrolled organizational entity must satisfy to be eligible for the affiliate program. In some embodiments, the set of criteria may further specify whether an organizational entity may be eligible for the affiliate program based on a relationship with a linked organizational entity.

In some embodiments, the candidate management circuitry 210 may evaluate whether a candidate user is eligible for the one or more affiliate programs based on a program affiliate repository. The organizational entities enrolled in the affiliate program may be stored and maintained in a program affiliate repository. A program affiliate repository may be a structured data repository or database configured to store a set of organizational entities enrolled in each offered affiliate program. The program affiliate repository may be queried by the candidate management circuitry 210 for a particular organizational entity and return each affiliate program the organizational entity is enrolled in. Alternatively, the program affiliate repository may be queried for a particular affiliate program and return each enrolled organizational entity enrolled in the particular affiliate program.

The program affiliate repository may be updated in response to changes made to affiliate programs and/or the one or more organizational entities enrolled in the affiliate program. For example, the program affiliate repository may be updated to reflect newly enrolled organizational entities upon completion of the enrollment process. As another example, the program affiliate repository may be updated to reflect organizational entities that opt to be removed from an affiliate program upon termination of their enrollment. As such, the information and/or data store by the program affiliate repository may be up-to-date and accurate.

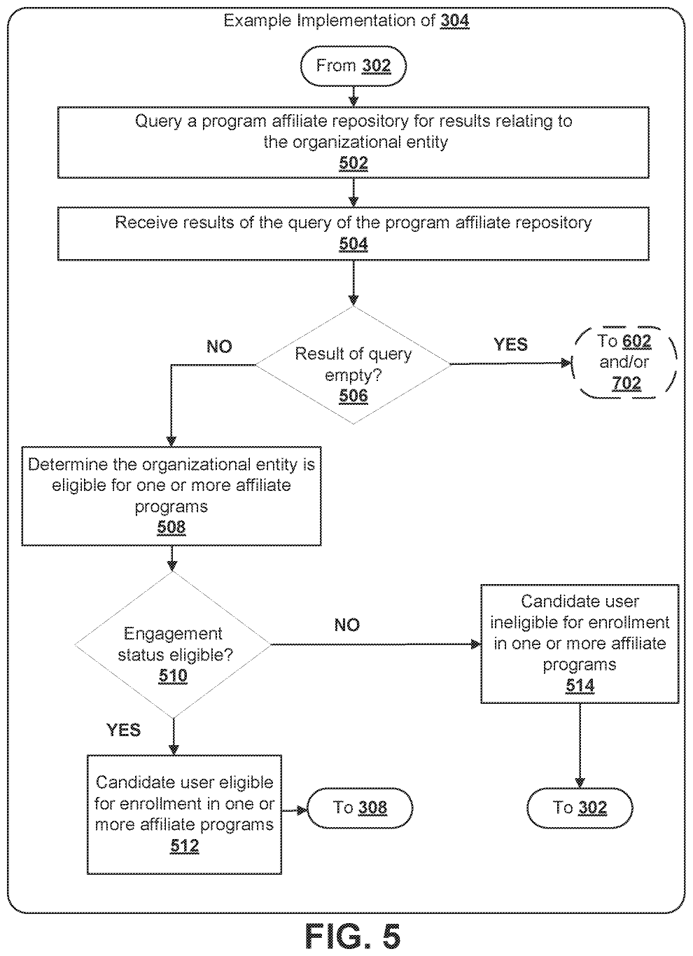

In some embodiments, operation 304 may be performed in accordance with the operations described by FIG. 5. Turning now to FIG. 5, example operations are shown for determining whether the candidate user is eligible for one or more affiliate programs.

As shown by operation 502, the apparatus 200 includes means, such as processor 202, memory 204, communications hardware 206, candidate management circuitry 210, or the like, for querying a program affiliate repository for results relating to the organizational entity. As described above, the program affiliate repository may be configured to store a set of organizational entities enrolled in each offered affiliate program. The candidate management circuitry 210 may then query the program affiliate repository for results relating to the organizational entity. In an instance the organizational entity is enrolled in one or more affiliate programs, the query will return the results of the affiliate programs the organizational entity is enrolled in. Otherwise, the result of the query will be empty.

As shown by operation 504, the apparatus 200 includes means, such as processor 202, memory 204, communications hardware 206, candidate management circuitry 210, or the like, for receiving results of the query of the program affiliate repository. As described above, if the organizational entity is currently enrolled in one or more affiliate programs, the result of the query performed in operation 502 will return with the affiliate programs the organizational entity is enrolled in. In an instance the organizational entity is not enrolled in any affiliate program, the results of the query will be empty. The results of the query include the one or more affiliate programs which identify the organizational entity as eligible.

As shown by operation 506, the apparatus 200 includes means, such as processor 202, memory 204, communications hardware 206, candidate management circuitry 210, or the like, for determining whether the result of the query is empty.

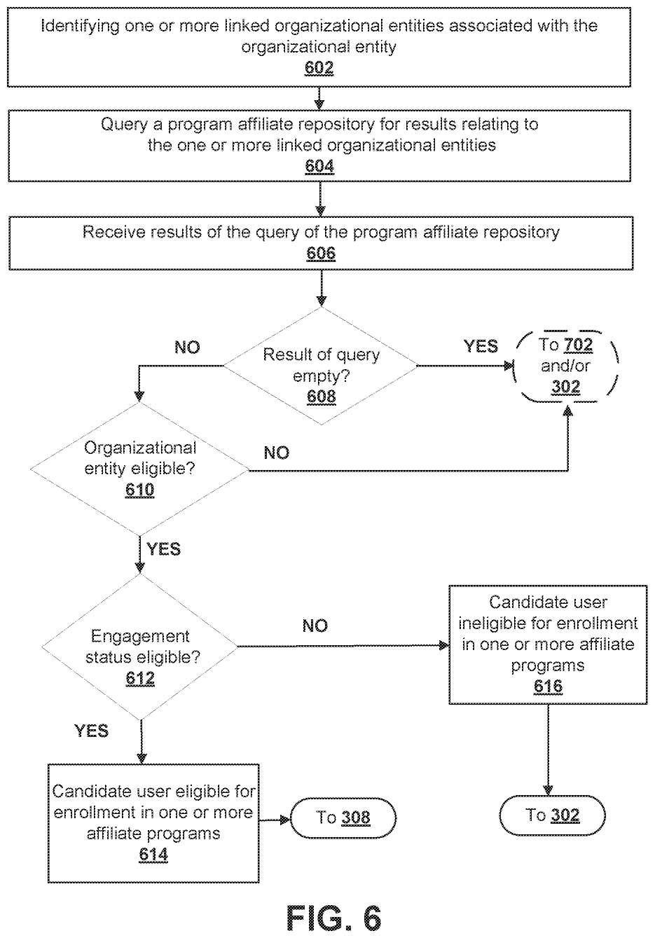

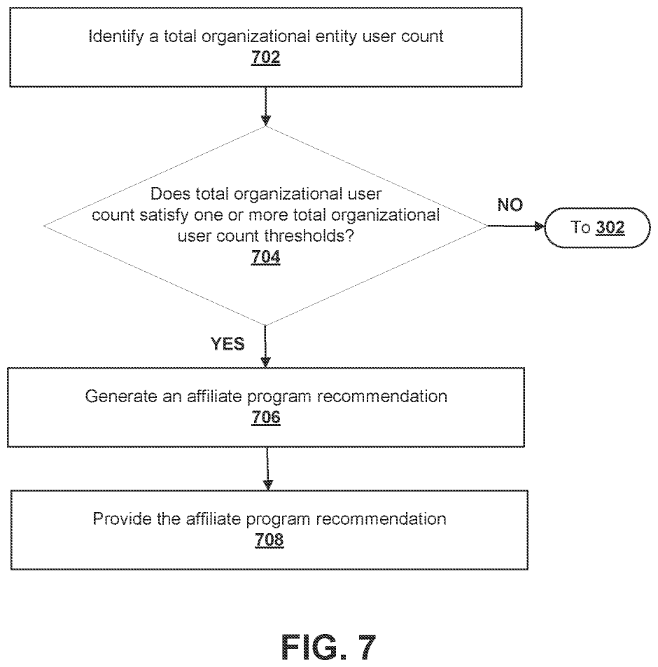

In an instance the result of the query is empty, the process may proceed to operation 602 and/or 702. At operation 602, the eligibility of the user will be evaluated based on one or more linked organizations that are associated with the organizational entity. For example, if a parent organization of the organizational entity is enrolled in one or more affiliate programs, the candidate user may be eligible for the one or more affiliate programs by way of the parent organization (e.g., a linked organizational entity). Additionally or alternatively, at operation 702, if the organizational entity and/or the one or more linked organizational entities are not found in the program affiliate repository, an affiliate program recommendation may be generated for the organizational entity if certain criteria is met. These operations will be discussed further in FIGS. 6 and 7.

In an instance the result of the query is not empty (e.g., the results of the query indicate one or more affiliate programs the organizational entity is enrolled in), the process may proceed to operation 508. As shown by operation 508, the apparatus 200 includes means, such as processor 202, memory 204, communications hardware 206, candidate management circuitry 210, or the like, for determining the organizational entity is eligible for one or more affiliate programs. In particular, the candidate management circuitry 210 may determine that the organizational entity is eligible for the one or more program entities included in the result of the query. As described above, in an instance the results of the query return with one or more affiliate programs, the included affiliate programs are the affiliate programs with which the organizational entity is currently enrolled. Thus, the organizational entity is eligible for these affiliate programs.

As shown by operation 510, the apparatus 200 includes means, such as processor 202, memory 204, communications hardware 206, candidate management circuitry 210, or the like, for determining whether the engagement status of the candidate user with respect to the organizational entity is eligible. As described above, each affiliate program may be associated with a set or criteria including one or more engagement statuses for a candidate user associated with an enrolled organizational entity. The candidate management circuitry 210 may then evaluate whether the engagement status of the user satisfies the set of criteria (e.g., corresponds to an engagement status that is indicated as acceptable or allowed by the affiliate program as described by the set of criteria) and determine whether the engagement status is eligible for the one or more affiliate programs. In an instance the engagement status of the candidate user corresponds to an allowed or accepted engagement status included in the set of criteria for an affiliate program, the engagement status of the candidate user is determined to be eligible. In an instance the engagement status of the candidate user fails to correspond to an allowed or accepted engagement status included in the set of criteria for an affiliate program, the engagement status of the candidate user is determined to be ineligible.

In an instance the engagement status of the candidate user with respect to the organizational entity is eligible for one or more affiliate programs, the process may proceed to operation 512. As shown by operation 512, the apparatus 200 includes means, such as processor 202, memory 204, communications hardware 206, candidate management circuitry 210, or the like, for determining the candidate user is eligible for one or more affiliate programs. Thus, at operation 512 the candidate management circuitry 210 may determine that the candidate user is eligible for the one or more affiliate programs for which the engagement status of the candidate user satisfies the set of criteria. The process may then proceed to operation 308.

In an instance the engagement status of the candidate user with respect to the organizational entity is ineligible for any affiliate program, the process may proceed to operation 514. As shown by operation 514, the apparatus 200 includes means, such as processor 202, memory 204, communications hardware 206, candidate management circuitry 210, or the like, for determining the candidate user is ineligible for in one or more affiliate programs. The process may then proceed to operation 302, where the eligibility of the candidate user for the one or more affiliate programs will be continued to be monitored.

Turning now to FIG. 6, example operations are shown for determining whether the candidate user is eligible for one or more affiliate programs based on one or more linked organizational entities associated with the organizational entity. In some embodiments, the operations depicted FIG. 6 may be performed in an instance the results of the query for the organizational entity in the program affiliate repository are empty, as illustrated in operation 506 of FIG. 5.

Additionally, although the operations described in FIG. 6 detail a separate query for one or more linked organizational entities from a query for an organizational entity, in some embodiments, the candidate management circuitry 210 may perform a query for the one or more linked organizational entities simultaneously with the query for the organizational entity. As such, any affiliate programs for which either the organizational entity or one or more linked entities are enrolled in may be determined with a single query.

As shown by operation 602, the apparatus 200 includes means, such as processor 202, memory 204, communications hardware 206, candidate management circuitry 210, or the like, for identifying one or more linked organizational entities associated with the organizational entity. A linked organizational entity may be an organizational entity that is associated with or related to the organizational entity in some form or fashion. For example, a linked organizational entity may be a parent company, a sister company, a subsidiary, an affiliate, a division, a branch, a joint venture, an acquired company, a DBA company, and/or the like with respect to the organizational entity. In some embodiments, a linked organizational entity may refer to a business, company, union, association, organization, and/or the like. In some embodiments, the linked organizational entity may be enrolled in one or more affiliate programs and/or may be eligible for enrollment in one or more affiliate programs. In an instance a linked organizational entity is enrolled in an affiliate program, the users associated with the linked organizational entity (e.g., employees, members, organizers, etc.) and in some embodiments, the organizational entity may be eligible for the services and benefits offered by the affiliate program by virtue of their association with the linked organizational entity and/or organizational entity.

In some embodiments, an organizational entity profile associated with the organizational entity may include an indication of one or more linked organizational entities associated with the organizational entity. For example, a graph structure, look-up table, reference table, and/or the like may be used to store and maintain relationships between the organizational entity and one or more linked organizational entities. For example, a node within a graph structure may indicate the organizational entity and the other nodes within the graph structure may indicate the linked organizational entities. The edges or connections between nodes may then indicate the relationship and/or connection between the organizational entity and linked organizational entities as well as the relationship and/or connection between linked organizational entities. In some embodiments, the edges may be directional such that the relationships and/or connections may be further described in the graph structure. For example, a directional edge directed away from a linked organizational entity node to the organizational entity node may indicate the organizational entity is a subsidiary of the linked organizational entity. Thus, the candidate management circuitry 210 may identify the one or more linked organizational entities based on the organizational entity profile.

As shown by operation 604, the apparatus 200 includes means, such as processor 202, memory 204, communications hardware 206, candidate management circuitry 210, querying the program affiliate repository for results relating to the one or more linked organizational entities. Similar to operation 504, the candidate management circuitry 210 may query the program affiliate repository for the one or more linked organizational entities. In an instance a linked organizational entity is enrolled in one or more affiliate programs, the query will return the results of the affiliate programs the linked organizational entity is enrolled in. Otherwise, the result of the query will be empty.

As shown by operation 606, the apparatus 200 includes means, such as processor 202, memory 204, communications hardware 206, candidate management circuitry 210, or the like, for receiving results of the query of the program affiliate repository. As described above, if the one or more linked organizational entities is currently enrolled in one or more affiliate programs, the result of the query performed in operation 604 will return with the affiliate programs the one or more organizational entities are enrolled in. In an instance the one or more linked organizational entities are not enrolled in any affiliate program, the results of the query will be empty. The results of the query include the one or more affiliate programs which identify the one or more linked organizational entities as eligible.

As shown by operation 608, the apparatus 200 includes means, such as processor 202, memory 204, communications hardware 206, candidate management circuitry 210, or the like, for determining whether the result of the query for the one or more linked organizational entities performed in operation 604 is empty. If one or more linked organizational entities are currently enrolled in one or more affiliate programs, the result of the query performed in operation 602 will return with the affiliate programs the linked organizational entities are enrolled in as well as an indication of which linked organizational entity is enrolled in which affiliate program. In an instance no linked organizational entities are enrolled in the one or more affiliate programs, the results of the query will be empty.

In an instance the result of the query is empty, the process may proceed to operation 702 and/or 302. At operation 702, if the organizational entity and/or the one or more linked organizational entities are not found in the program affiliate repository, an affiliate program recommendation may be generated for the organizational entity if certain criteria is met. These operations will be discussed further in FIG. 7. Additionally or alternatively, the process may proceed to operation 302, where the eligibility of the candidate user for the one or more affiliate programs will be continued to be monitored.

In an instance the result of the query is not empty, the process may proceed to operation 610. As shown by operation 610, the apparatus 200 includes means, such as processor 202, memory 204, communications hardware 206, candidate management circuitry 210, or the like, for determining whether the organizational entity is eligible for one or more affiliate programs by way of the associated one or more linked organizational entities. As described above, in some embodiments, the set of criteria of an affiliate program may specify whether an organizational entity may be eligible for the affiliate program based on a relationship with a linked organizational entity. The candidate management circuitry 210 may thus evaluate the set of criteria associated with each returned affiliate program to determine whether the organizational entity is eligible for the one or more affiliate programs by virtue of its relationship with the one or more linked organizational entities.

In an instance the organizational entity is not eligible for the one or more affiliate programs, the process may proceed to operation 702 and/or 302.

In an instance the organizational entity is eligible for the one or more affiliate programs, the process may proceed to operation 612. As shown by operation 612, the apparatus 200 includes means, such as processor 202, memory 204, communications hardware 206, candidate management circuitry 210, or the like, for determining whether the engagement status of the candidate user with respect to the organizational entity is eligible. Similar to operation 510, the candidate management circuitry 210 may evaluate whether the engagement status of the user satisfies the set of criteria (e.g., corresponds to an engagement status that is indicated as acceptable or allowed by the affiliate program as described by the set of criteria) and determine whether the engagement status is eligible for the one or more affiliate programs. In an instance the engagement status of the candidate user corresponds to an allowed or accepted engagement status included in the set of criteria for an affiliate program, the engagement status of the candidate user is determined to be eligible. In an instance the engagement status of the candidate user fails to correspond to an allowed or accepted engagement status included in the set of criteria for an affiliate program, the engagement status of the candidate user is determined to be ineligible.

In an instance the engagement status of the candidate user with respect to the organizational entity is eligible, the process may proceed to operation 614. As shown by operation 614, the apparatus 200 includes means, such as processor 202, memory 204, communications hardware 206, candidate management circuitry 210, or the like, for determining the candidate user is eligible for one or more affiliate programs. Thus, at operation 614 the candidate management circuitry 210 may determine that the candidate user is eligible for the one or more affiliate programs for which the engagement status of the candidate user satisfies the set of criteria. The process may then proceed to operation 308.

In an instance the engagement status of the candidate user with respect to the organizational entity is ineligible, the process may proceed to operation 616. As shown by operation 616, the apparatus 200 includes means, such as processor 202, memory 204, communications hardware 206, candidate management circuitry 210, or the like, for determining the candidate user is ineligible for one or more affiliate programs. The process may then proceed to operation 302, where the eligibility of the candidate user for the one or more affiliate programs will be continued to be monitored.

Returning now to FIG. 3, as shown by operation 306, the apparatus 200 includes means, such as processor 202, memory 204, communications hardware 206, candidate management circuitry 210, or the like, for determining whether the candidate user is eligible for the one or more affiliate programs. As described above, via the various operations of FIGS. 5 and 6, the candidate user may be evaluated to determine whether he/she is eligible for the one or more affiliate programs.

In an instance the candidate user is determined to be ineligible for one or more programs, the process proceeds to operation 302. For example, as described above, if the organizational entity associated with the candidate user and/or one or more linked organizational entities are not found in the program affiliate repository and/or the engagement status of the candidate user is ineligible, the candidate user may be determined to be ineligible for any affiliate program. As such, the process may return back to operation 302, where the eligibility of the candidate user may be re-evaluated periodically or semi-periodically. For example, the eligibility of the candidate user may be updated in response to receiving new information (e.g., new internal source data) and/or in response to an update to the program affiliate repository. In some embodiments, the candidate user and/or one or more other users (e.g., institution employees) may also request the eligibility of the candidate user be re-evaluated. As such, even in an instance the candidate user is not currently eligible for the one or more affiliate programs, any changes that occur with the candidate user with respect to an organizational entity (e.g., begin employment at the organizational entity, switch roles within the organizational entity, etc.) will be considered in future eligibility determinations and may in fact, prompt the candidate management system to re-evaluate the candidate user for eligibility.

In an instance the candidate user is determined to be eligible for one or more programs, the process proceeds to operation 308. As shown by operation 308, the apparatus 200 includes means, such as processor 202, memory 204, communications hardware 206, candidate management circuitry 210, or the like, for generating an eligibility notification. As described above, if the organizational entity associated with the candidate user and/or one or more linked organizational entities are determined to be eligible for one or more affiliate programs and the engagement status of the candidate user is eligible, the candidate user may be determined to be eligible for the one or more affiliate programs (e.g., as described by the results of the query of the program affiliate repository). Thus, the candidate management circuitry 210 may generate an eligibility notification for the candidate user.

The eligibility notification may describe the one or more affiliate programs the candidate user is eligible. For example, the eligibility notification may include additional information regarding each affiliate program such as the various services or benefits offered by the affiliate program. The eligibility notification may further indicate how the candidate user may sign-up or enroll in the affiliate program.

Optionally, as shown by operation 310, the apparatus 200 includes means, such as processor 202, memory 204, communications hardware 206, candidate management circuitry 210 or the like, for determining one or more communication channels (e.g., SMS text, email, mail, pre-recorded voice calls, facility devices such as automated teller machines (ATMs)) over which to provide the eligibility notification. In some embodiments, the candidate management circuitry 210 may access a user profile of the candidate user to determine user contact preferences or the like. The candidate management circuitry 210 may then determine the one or more communication channels over which to provide the eligibility notification based on the user contact preferences. For example, the user may indicate they prefer emails and thus the candidate management circuitry 210 may determine to provide the eligibility notification via an email communication channel. The particular values (e.g., a telephone number, email address, mailing address, etc.) of the communication channel may be accessed and/or otherwise determined using the user profile associated with the candidate user.

In some embodiments, the candidate management circuitry 210 may also select a facility communication channel and may append or otherwise add the eligibility notification to the candidate user's user profile such that the next time they interact with a facility device (e.g., any one of facility devices 108A-108N), the eligibility notification may be provided to the candidate user via the facility device. For example, a candidate user may access and ATM and in an instance an eligibility notification is associated with the associated user profile, the eligibility notification may be rendered and displayed on the ATM for the candidate user.

Optionally, as shown by operation 312, the apparatus 200 includes means, such as processor 202, memory 204, communications hardware 206, candidate management circuitry 210, or the like, for determining one or more trigger events for the eligibility notification. In some embodiments, the candidate management circuitry may determine one or more trigger events that may cause or prompt the eligibility notification to be provided to the candidate user. The candidate management circuitry 210 may determine the one or more trigger events based on a variety of factors such as when an eligibility notification was last provided, recent candidate user interaction with a facility device, an inferred user event, and/or the like.

In some embodiments, the candidate management circuitry 210 may determine the time stamp of when an eligibility notification that included a particular affiliate program was last provided to the candidate user. For example, if the candidate user is newly qualified for the affiliate program such that no eligibility notification has been previously provided, the candidate management circuitry 210 may determine a trigger event of “as soon as possible” such that an eligibility notification may provided via a select communication channel at the next opportunity. For example, if a preferred communication channel of the user is a SMS text, the candidate management circuitry 210 may determine to provide the eligibility notification immediately such that the eligibility notification is received by a client device (e.g., any one of client devices 106A-106N) in real-time or near real-time. As another example, if a preferred communication channel is a facility device (e.g., any one of facility devices 108A-108N), the eligibility notification may be provided to the facility device the next time the candidate user interacts with a facility device.

In some embodiments, the candidate management circuitry 210 may determine to provide the eligibility notification in response to detection of one or more inferred user events. For example, in some embodiments, certain affiliate programs may be particularly beneficial at certain critical time points that correspond to a candidate user event. For example, a corporate mortgage benefit program may be particularly beneficial in an instance a candidate user is starting a new job, has recently left a job, has recently retired, has expanded his/her family, has expressed interest in a mortgage or re-financing, and/or the like. As such, the candidate management circuitry 210 may identify one or more relevant inferred user events that pertain to the particular affiliate program the candidate user is eligible for and may determine these inferred user events to be trigger events. In some embodiments, the affiliate program may be associated and/or stored with relevant inferred user events such that the candidate management circuitry 210 may identify the one or more relevant inferred user events based on the inferred user events associated and/or stored with the affiliate program.

The candidate management circuitry 210 may continuously monitor for the one or more inferred user events such that it may be responsive to the trigger events and can provide the one or more eligibility notifications in real-time or near real-time. In some embodiments, the candidate management circuitry 210 may identify a trigger event by leveraging the current engagement status of the candidate user and/or a recently changed engagement status of the candidate user. For example, the candidate management circuitry 210 may identify a “new job” trigger event in an instance the engagement status of the candidate user is “newly employed”. As another example, the candidate management circuitry 210 may identify a “retired” trigger event in an instance the engagement status of the candidate user is “retired”.

In some embodiments, the candidate management circuitry 210 may receive an indication of recent user queries made by the candidate user and may determine a trigger event based on a user query. Recent user queries may be logged and stored in an associated user profile such that the candidate management circuitry 210 may access and analyze these queries. For example, a user query may include an inquiry into mortgage costs or rates or may even include an incomplete or submitted mortgage application. The candidate management circuitry 210 may identify these queries as an “expressed interest in a mortgage” trigger event.

In some embodiments, the candidate management circuitry 210 may use one or more event inference models to monitor and detect whether one or more trigger events have occurred for the candidate user. The one or more event inference models may be trained machine learning models (e.g., neural networks) trained to identify and determine user events based on user patterns identified within stored user data. The one or more event inference models may analyze user data associated with the user profile of the candidate user to detect any deviations in user data that may indicate an inferred user event. For example, in an instance the amount of a new direct deposit has increased significantly from historical direct deposit amounts, the one or more inference models may determine that a promotion inferred user event has occurred. As another example, the event inference model may determine that the candidate user has recently opened a joint bank account with another user and may thus determine a marriage inferred user event has occurred. As yet another example, the event inference model may determine one or more candidate user accounts have recently for various purchases at baby or children stores and thus may determine a new child inferred user event has occurred. The one or more inferred user events may be output to the candidate management circuitry 210. Thus, the candidate management circuitry 210 may provide an eligibility notification that is responsive to an inferred user event.

As shown by operation 314, the apparatus 200 includes means, such as processor 202, memory 204, communications hardware 206, candidate management circuitry 210, or the like, for providing the eligibility notification to the candidate user. In some embodiments, the candidate management circuitry 210 may provide the eligibility notification to the candidate user over the one or more communication channels determined in operation 312 and/or in response to detection of one or more trigger events. As such, the candidate user may be automatically informed of his/her eligibility for the one or more affiliate programs without requiring any intervention of the associated organizational entity.

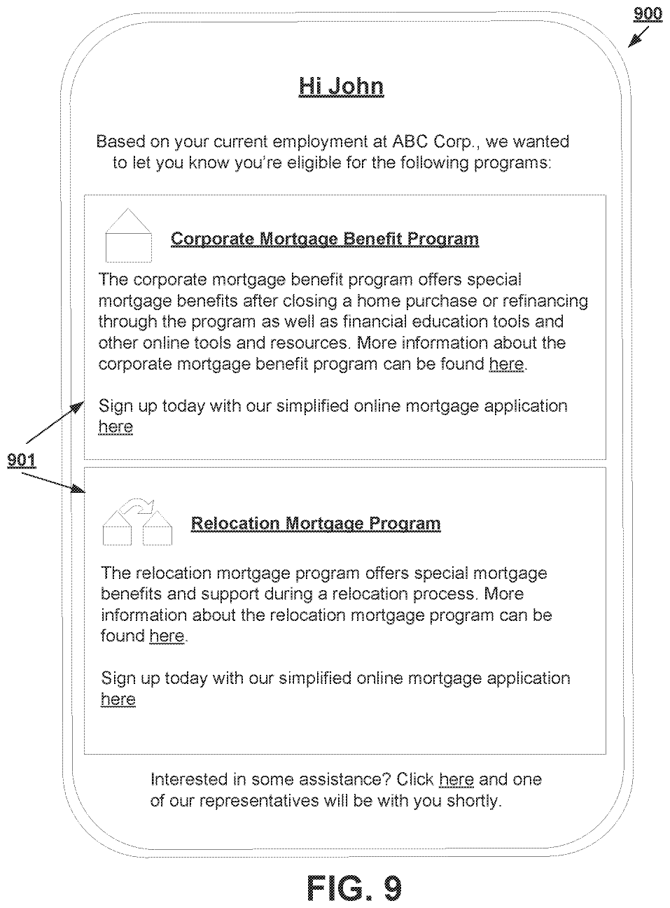

FIG. 9 depicts a graphical user interface (GUI) that illustrates an example eligibility notification 900. In some embodiments, the candidate user may interact with the candidate management system 102 by directly engaging with communications hardware 206 of an apparatus 200. In such an embodiment, the GUI shown in FIG. 9 may be displayed to the candidate user by the apparatus 200. Alternatively, a candidate user may interact with the candidate management system 102 using a separate client device (e.g., any of client devices 106A-106N, as shown in FIG. 1), which may communicate with the candidate management system 102 via communications network 104. In such an embodiment, the GUI shown in FIG. 9 may be displayed to the user by the client device. Alternatively, a candidate user may interact with the candidate management system 102 using a separate facility device (e.g., any of facility devices 108A-108N, as shown in FIG. 1), which may communicate with the candidate management system 102 via communications network 104. In such an embodiment, the GUI shown in FIG. 9 may be displayed to the user by the facility device.

As shown in the eligibility notification 900, the one or more affiliate programs 901 for which the candidate user is determined to be eligible for is displayed to the user. Each affiliate program may include a description and in this particular example, may include user interaction tools that cause a user to be directed to a relevant website to continue to engage with a particular affiliate program.

Turning next to FIG. 7, example operations are shown for providing an affiliate program recommendation. More particularly, via the operations described in FIG. 7, an organizational entity which is not currently enrolled in one or more affiliate programs but satisfies certain criteria may be informed of their eligibility via an affiliate program recommendation. Additionally, the affiliate program recommendation may include an indication of a total number of users associated with the organizational entity who are affiliated with the particular institution offering the one or more affiliate programs. Thus, the organizational entity may perform a more thorough assessment and determine whether the one or more affiliate programs may be advantageous.

As shown by operation 702, the apparatus 200 includes means, such as processor 202, memory 204, communications hardware 206, candidate management circuitry 210, or the like, for identifying a total organizational entity user count. In some embodiments, the candidate management circuitry 210 may consider the users, including the candidate user, associated with a particular organizational entity in aggregate. The candidate management circuitry 210 may then determine a total organizational entity user count by summing the total number of users determined to be associated with the organizational entity and who have a qualifying engagement status. For example, the candidate management circuitry 210 may sum the total number of users associated with a particular organizational entity who are also associated with an engagement status of “employed” and “recently employed” to determine a total organizational entity user count.

As shown by operation 704, the apparatus 200 includes means, such as processor 202, memory 204, communications hardware 206, candidate management circuitry 210, or the like, for determining whether the total organizational user count satisfies one or more total organizational user count thresholds. As described above, in some embodiments, an affiliate program may be associated with a set of criteria that specifies a required total organizational user count threshold which the organizational entity must satisfy to be enrolled in the affiliate program. Thus, the candidate management circuitry 210 may compare the total organizational entity user count as determined in operation 702 to the one or more total organizational user count thresholds. For example, a total organizational entity user count threshold may indicate that an organizational entity must have a total organizational entity user count of 500 or more to satisfy the set of criteria. As such, in an instance the total organizational entity user count of the organizational entity is 500 or greater, the total organizational entity user count may satisfy the one or more total organizational entity user count thresholds.

In an instance the total organizational user count does not satisfy the one or more total organizational user count thresholds, the process may proceed to operation 302, where the candidate user may continued to be monitored to determine whether or not they may be eligible for one or more affiliate programs in the future. Additionally, the candidate management circuitry 210 may continue to monitor and update the total organizational entity user count for the organizational entity and continue to monitor whether the organizational entity may be eligible for one or more affiliate programs it is not already enrolled in.

In an instance the total organizational user count satisfies the one or more total organizational user count thresholds, the process may proceed to operation 302. At operation 706, the apparatus 200 includes means, such as processor 202, memory 204, communications hardware 206, candidate management circuitry 210, or the like, for generating an affiliate program recommendation. The affiliate program recommendation may indicate the one or more affiliate programs the organizational entity is not currently enrolled in but is eligible for. Additionally, the affiliate program recommendation may further indicate detailed information such as the services and/or benefits offered by each affiliate program. As such, one or more end users (e.g., administrators, policy makers, etc.) may be informed that the organizational entity is eligible for said affiliate programs. In some embodiments, the affiliate program recommendation may include the total organizational entity user count such that the one or more end users may further be made aware of the potential scale of impact the one or more affiliate programs may have on the associated users and thus, may allow the end users to may make a more informed choice on whether to enroll in the affiliate programs.

At operation 708, the apparatus 200 includes means, such as processor 202, memory 204, communications hardware 206, candidate management circuitry 210, or the like, for providing the affiliate program recommendation. The candidate management circuitry 210 may then provide the affiliate program recommendation to one or more entity devices (e.g., any one of entity devices 120A-120N). In particular, the affiliate program recommendation may be provided to one or more users who are determined to be benefit coordinators, administrators, or serve some other management role within the organizational entity. In some embodiments, the organizational entity may already be enrolled in one or more other affiliate programs such that appropriate users may be identified in a corresponding organizational entity profile. Additionally or alternatively, in some embodiments, the candidate management circuitry 210 may identify and determine this information via various online queries or via third-party data bases and repositories.

FIGS. 4, 5, 6, and 7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

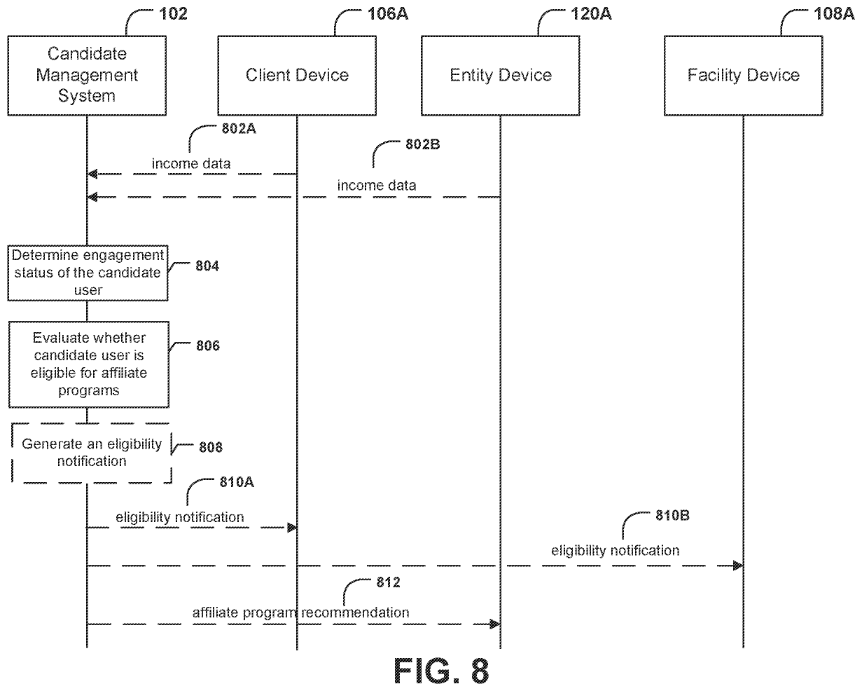

FIG. 8 shows a swim lane diagram illustrating example operations (e.g., as described above in connection with FIGS. 3-7) performed by components of the environment depicted in FIG. 1 to produce various benefits of the implementations described herein. The operations shown in the swim lane diagram performed by the candidate management system 102 are shown along the line extending from the box labeled “candidate management system 102,” operations performed by a client device (e.g., any one of client devices 106A-106N) are shown along the line extending from the box labeled “client device 106A,” operations performed by entity device (e.g., any one of entity device 120A-120N) are shown along the line extending from the box labeled “entity device 120A,” and operations performed by facility device (e.g., any one of facility devices 108A-108N) are shown along the line extending from the box labeled “facility device 108A.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIG. 8.

At operation 802A and/or 802B, the candidate management system 102 may receive income data, which may be provided by either client device 106A and/or entity device 120A. At operation 804, the candidate management system may determine an engagement status of the candidate user associated with the received income data. At operation 806, the candidate management system 102 may evaluate whether the candidate user is eligible for one or more affiliate programs. At operation 808, in an instance the candidate user is eligible for one or more affiliate programs, the candidate management system 102 may generate an eligibility notification for the candidate user indicating their eligibility for the one or more affiliate programs. At operation 810A and/or 810B, the candidate management system 102 may provide the eligibility notification to the client device 106A and/or the facility device 108A. The particular device the candidate management system 102 provides the eligibility notification to may depend on the one or more determined communication channels for the eligibility notification. At operation 812, the candidate management system 102 may provide the facility device with an affiliate program recommendation in an instance the candidate management system determines the total organizational user count of the organizational entity satisfies one or more total organizational user count thresholds of one or more affiliate programs.

In some embodiments, some of the operations described above in connection with FIGS. 3-7 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved assessment of user eligibility for one or more affiliate programs. Example embodiments thus provide tools that overcome the problems faced by relying on organizational entities to communicate a user eligibility to the users, as is conventionally performed. This conventional reliance on organizational entities to inform its user of their eligibility in affiliate programs is not only inefficient as oftentimes the representatives of the organizational entity themselves are not equipped to handle inquiries or questions about affiliate programs but may also be resource intensive for the organizational entity.

The above described embodiments address these technical issues by proactively identifying the eligibility of users associated with an organizational entity that is enrolled in one or more offered affiliate programs and furthermore, provide them with a notification of their eligibility for said affiliate programs. As such, these users may take advantage of these offered services and benefits of the affiliate program and may further be in a position to ask informed parties (associated with the affiliate programs) any questions they may have, thereby streamlining communications and enhancing the overall user experience. Additionally, even in an instance the engagement status of the user is ineligible and/or the organizational entity is not enrolled in one or more affiliate programs, the system may continue to monitor and/or identify internal source data pertaining to the user and may re-evaluate user eligibility based on new data.

Furthermore, in some embodiments, certain trigger events may be identified for a user via the internal source data and may cause the eligibility of the user to be evaluated. As such, a dynamic and real-time eligibility determination may be made for the user and the user may be informed of their eligibility in one or more affiliate programs such that they may take advantage of the offered services and/or benefits. For example, a job change (inferred via the internal source data) may be a trigger event that is identified for a user and the new employer of the user may be identified from the internal source data. If the new employer is enrolled in an affiliate program, such as the corporate mortgage benefit program, the user may be informed of this via an eligibility notification and may thus inform the user of this such that he/she may engage with the program's offered services and benefits to help facilitate a required move and purchase of a new house.

Additionally, the eligibility of a user may additionally or alternatively be evaluated based on a linked organizational entity rather than the organizational entity the user is directly associated with. For example, if the organizational entity is a subsidiary of a parent linked organizational entity, the enrollment of the linked organizational entity in one or more affiliate programs may be evaluated. If the linked organizational entity is determined to be associated with one or more affiliate programs, then a set of criteria for each affiliate program may be evaluated to determine whether a user of the organizational entity may be eligible for the affiliate program via the relationship by virtue of the relationship between the organizational entity and the linked organizational entity. Thus, this may allow for more robust and comprehensive user eligibility determinations to be made. Traditionally, users associated with an organizational entity may be largely uninformed or unaware of the potential benefits offered by an affiliate program they may be eligible for in an instance a linked organizational entity is enrolled in the affiliate program, but the organizational entity directly associated with the users is not.

Furthermore, in some embodiments, even in instances when an organizational entity is not currently enrolled in any affiliate programs or is not enrolled in a particular affiliate program, many users associated with the organizational entity may currently be associated with the entity offering the one or more affiliate programs. For example, many employees of a certain company that is currently not enrolled in any affiliate programs may be current customers of a particular financial institution which offers said affiliate programs. As such, a large number of employees of the company may benefit from the affiliate program in an instance the company was enrolled in an affiliate program. As such, in some embodiments, an affiliate program recommendation may be generated for organizational entities which are currently not enrolled in any affiliate programs or in a particular affiliate program such that the organizational entity is made aware of the potential benefit to be had via enrollment into an affiliate program.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for assessing affiliate program eligibility of a candidate user, the method comprising:
determining, by user evaluation circuitry and using a processing model, an organizational entity associated with the candidate user by processing one or more of (a) direct deposit documents, (b) paycheck documents, or (c) self-reported income;
determining, by the user evaluation circuitry and using an inference model, an engagement status of the candidate user with respect to the organizational entity associated with the candidate user based on internal source data;
evaluating, by candidate management circuitry and based on the engagement status of the candidate user with respect to the organizational entity, whether the candidate user is eligible for one or more affiliate programs;
in an instance in which the candidate user is eligible in at least one of the one or more affiliate programs, generating, by the candidate management circuitry, an eligibility notification, wherein the eligibility notification describes the one or more affiliate programs for which the candidate user is eligible;
continuously monitoring, by the candidate management circuitry and using an event inference model, the internal source data for occurrence of one or more trigger events:
in response to continually monitoring the internal source data, detecting, by the candidate management circuitry, an occurrence of the one or more trigger events; and
in response to detecting occurrence of the one or more trigger events, providing, by communications hardware, the eligibility notification to the candidate user.

2. The method of claim 1, further comprising;
querying, by the candidate management circuitry, a program affiliate repository for results relating to the organizational entity, wherein (i) the program affiliate repository describes one or more of the one or more affiliate programs and (ii) each affiliate program identifies one or more eligible organizational entities;
receiving, by the candidate management circuitry, results of the query of the program affiliate repository, wherein the results of the query of the program affiliate repository comprise one or more affiliate programs that identify the organizational entity as eligible; and
determining, by the candidate management circuitry and using the processing model and based on the results of the query, that the organizational entity is eligible for the one or more affiliate programs.

3. The method of claim 2, wherein evaluating whether the candidate user is eligible for the one or more affiliate programs comprises, for each affiliate program of the one or more affiliate programs that identify the organizational entity as eligible:
determining, by the candidate management circuitry, whether the engagement status corresponds to one or more eligible engagement statuses for the affiliate program; and
in an instance in which the engagement status corresponds to one or more eligible engagement statuses for the affiliate program, determining that the candidate user is eligible for the affiliate program.

4. The method of claim 2, further comprising:
identifying, by the candidate management circuitry, one or more linked organizational entities associated with the organizational entity.

5. The method of claim 4, further comprising:
in an instance in which the results of the query of the program affiliate repository for the organizational entity is empty, querying, by the candidate management circuitry, the program affiliate repository for results relating to the one or more linked organizational entities;
receiving, by the candidate management circuitry, results of the query of the program affiliate repository, wherein the results of the query of the program affiliate repository comprise one or more affiliate programs that identify the one or more linked organizational entities as eligible; and
determining, by the candidate management circuitry, that the organizational entity is eligible for the one or more affiliate programs based on results of the query of the program affiliate repository for the one or more linked organizational entities.

6. The method of claim 4, further comprising:
querying, by the candidate management circuitry, the program affiliate repository for the one or more linked organizational entity simultaneously with the query for the organizational entity.

7. The method of claim 2, further comprising:
in an instance in which the results of the query of the program affiliate repository for the organizational entity is empty:
identifying, by the candidate management circuitry, a total organizational entity user count, wherein the total organizational entity user count includes users who are associated with the organizational entity and have an engagement status with respect to the organizational entity which corresponds to one or more eligible engagement statuses;
in an instance in which the total organizational entity user count satisfies one or more total organizational entity user count thresholds, generating, by the candidate management circuitry, an affiliate program recommendation, wherein the affiliate program recommendation comprises one or more affiliate programs for which the organizational entity is eligible; and
providing, by the communications hardware, the affiliate program recommendation.

8. The method of claim 7, wherein the affiliate program recommendation further comprises an indication of the total organizational entity user count.

9. (canceled)

10. The method of claim 1, further comprising:
identifying, by the user evaluation circuitry, temporal information described by the internal source data; and
determining, by the user evaluation circuitry and using the inference model, the engagement status of the candidate user with respect to the identified organizational entity based on the temporal information.

11. The method of claim 10, further comprising:
identifying, by the user evaluation circuitry, demographic information pertaining to the candidate user, wherein determining the engagement status of the candidate user with respect to the identified organizational entity is further based on the demographic information.

12. (canceled)

13. The method of claim 1, further comprising:
determining, by the candidate management circuitry, one or more communication channels over which to provide the eligibility notification, wherein the eligibility notification is provided to the candidate user over the one or more determined communication channels.

14. The method of claim 1, further comprising:
determining, by the candidate management circuitry, the one or more trigger events for eligibility notification, wherein the one or more trigger events include at least one of a recency of a prior eligibility notification, a detection of a user interaction with a facility device, a detection of an occurrence of a particular user event, or a detection of a particular user query.

15. An apparatus for assessing affiliate program eligibility of a candidate user, the apparatus comprising:
user evaluation circuitry configured to:
determine, using a processing model, an organizational entity associated with the candidate user by processing one or more of (a) direct deposit documents, (b) paycheck documents, or (c) self-reported income, and
determine, using an inference model, an engagement status of the candidate user with respect to the organizational entity determined to be associated with the candidate user based on internal source data;
candidate management circuitry configured to:
evaluate, based on the engagement status of the candidate user with respect to the organizational entity, whether the candidate user is eligible for one or more affiliate programs,
continuously monitor, using an event inference model, the internal source data for occurrence of one or more trigger events,
in response to continually monitoring the internal source data, detect an occurrence of the one or more trigger events, and
in an instance in which the candidate user is eligible in at least one of the one or more affiliate programs, generate an eligibility notification, wherein the eligibility notification describes the one or more affiliate programs for which the candidate user is eligible; and
communications hardware configured to provide the eligibility notification to the candidate user in response to detecting occurrence of the one or more trigger events.

16. The apparatus of claim 15, wherein the candidate management circuitry is further configured to:
query a program affiliate repository for results relating to the organizational entity, wherein (i) the program affiliate repository describes one or more of the one or more affiliate programs and (ii) each affiliate program identifies one or more eligible organizational entities;
receive results of the query of the program affiliate repository, wherein the results of the query of the program affiliate repository comprise one or more affiliate programs that identify the organizational entity as eligible; and
determine, using the processing model and based on the results of the query, that the organizational entity is eligible for the one or more affiliate programs.

17. The apparatus of claim 16, wherein the candidate management circuitry is further configured to, for each affiliate program of the one or more affiliate programs that identify the organizational entity as eligible:
determine whether the engagement status corresponds to one or more eligible engagement statuses for the affiliate program; and
in an instance in which the engagement status corresponds to one or more eligible engagement statuses for the affiliate program, determine that the candidate user is eligible for the affiliate program.

18. The apparatus of claim 16, wherein the candidate management circuitry is further configured to:
identify one or more linked organizational entities associated with the organizational entity.

19. The apparatus of claim 18, wherein the candidate management circuitry is further configured to:
in an instance in which the results of the query of the program affiliate repository for the organizational entity is empty, query the program affiliate repository for results relating to the one or more linked organizational entities;
receive results of the query of the program affiliate repository, wherein the results of the query of the program affiliate repository comprise one or more affiliate programs that identify the one or more linked organizational entities as eligible; and
determine that the organizational entity is eligible for the one or more affiliate programs based on results of the query of the program affiliate repository for the one or more linked organizational entities.

20. A computer program product for assessing affiliate program eligibility of a candidate user, the computer program product comprising at least one non-transitory computer-readable storage medium storing software instructions that, when executed, cause an apparatus to:
determine, using a processing model, an organizational entity associated with the candidate user by processing one or more of (a) direct deposit documents, (b) paycheck documents, or (c) self-reported income;
determine, using an inference model, an engagement status of the candidate user with respect to the organizational entity associated with the candidate user based on internal source data;
evaluate, based on the engagement status of the candidate user with respect to the organizational entity, whether the candidate user is eligible for one or more affiliate programs;
in an instance in which the candidate user is eligible in at least one of the one or more affiliate programs, generate an eligibility notification, wherein the eligibility notification describes the one or more affiliate programs for which the candidate user is eligible;
continuously monitor, using an event inference model, the internal source data for occurrence of one or more trigger events:
in response to continually monitoring the internal source data, detect an occurrence of the one or more trigger events; and
in response to detecting occurrence of the one or more trigger events, provide the eligibility notification to the candidate user.

21. The apparatus of claim 15, wherein the user evaluation circuitry is further configured to:
identify temporal information described by the internal source data; and
determine, using the processing model, the engagement status of the candidate user with respect to the identified organizational entity based on the temporal information.

22. The apparatus of claim 21, wherein the user evaluation circuitry is further configured to identify demographic information pertaining to the candidate user, wherein determining the engagement status of the candidate user with respect to the identified organizational entity is further based on the demographic information.

23. The method of claim 1, wherein detecting the occurrence of the one or more trigger events comprises:
detecting, by the candidate management circuitry and using a trained neural network, the occurrence of the one or more trigger events based on patterns within stored user data.
